(19) United States
(12) Patent Application Publication
(10) Pub. No.: US 2008/0092975 A1
(43) Pub. Date: Apr. 24, 2008

(54) Heater core connector

(76) Inventors: David L. Grimes, South Lyon, MI (US); Richard Kenneth Harris, Pinckney, MI (US); Steven A. White, Horton, MI (US)

Correspondence Address: FRASER CLEMENS MARTIN & MILLER LLC, 28366 KENSINGTON LANE, PERRYSBURG, OH, 43551, US

(21) Appl. No.: 11/521,878

(22) Filed: Sep. 15, 2006

(51) Int. Cl. F16L 9/02; F16L 43/00; B21D 9/00

(52) U.S. Cl. 138/177; 285/179; 72/369

(57) ABSTRACT

A small bend radius connector for a heater core is shown, wherein a first end of the connector has a rectangular cross section, a second end of the connector has a circular cross section, and wherein a size, a weight, and a cost of production of the connector are minimized.

### FIELD OF THE INVENTION

The present invention relates to a connector and more particularly to a connector having a minimized bend radius for use with a heater core in a vehicle.

### BACKGROUND OF THE INVENTION

Heater core connectors are typically used to connect heat exchanger tanks to other components in a vehicle. Ideally, the connectors have low profiles to comply with packaging requirements and facilitate a fluid tight seal between the heat exchanger tank and the other components.

Prior art connectors are typically comprised of single or multiple stamped pieces that are brazed together with the heat exchanger to form a fluid-tight connection therebetween. However, the brazing employed on multiple-piece connectors often leaves the connection prone to leaking as well as limiting the available options for connection to extension tubes. Typical stamped single-piece connectors only allow for circular inlet or outlet configurations and thereby limit the fluid circuit and subsequently the efficiency of the heat exchanger device.

To overcome this problem, heater core connectors have been formed from a single piece of material that is bent to form a desired angle, wherein the brazing step is eliminated. Typical design guides recommend that a minimum bend radius of a tube section is two and one half times a diameter of the section. Such a bend radius yields connectors having lengths that are two to three times the diameter of the connector. Such lengths are undesirable due to packaging limitations that require the connector to have smaller profiles.

It would be desirable to produce a connector having a small bend radius for a heater core of a vehicle, wherein a size, a weight, and a cost of production thereof are minimized and wherein the connector militates against leakage.

### SUMMARY OF THE INVENTION

Harmonious with the present invention, a connector having a small bend radius for a heater core of a vehicle, wherein a size, a weight, and a cost of production thereof are minimized and wherein the connector militates against leakage, has surprisingly been discovered.

In one embodiment, a tube comprises: a hollow conduit having a first end, a spaced apart second end, and an intermediate portion, the intermediate portion having a bend formed therein, wherein a radius of the bend is less than a diameter of the conduit.

In another embodiment, a tube comprises: a hollow conduit having a first end, a spaced apart second end, and an intermediate portion, wherein the first end is adapted to be connected to a heat exchanger tank, the second end is adapted to be connected to a connector tube, and the intermediate portion includes a bend formed therein, wherein the bend has a radius that is less than a diameter of the hollow conduit and the conduit has a length that is less than three times the diameter thereof.

A method of forming a tube for a heat exchanger is disclosed, the method comprising the steps of: providing a hollow conduit; cutting the conduit to a desired length; and forming a bend in the conduit, wherein the bend is approximately ninety degrees and has a bend radius that is less than the diameter of the tube.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings in which:

FIG. 1 is a cross-sectional side view of a tube in accordance with an embodiment of the invention; and

FIG. 2 is a perspective view of the conduit illustrated in FIG. 1, after the conduit has been cut to a desired length;

FIG. 3 is a perspective view of the conduit illustrated in FIG. 1, after the conduit has been formed into a substantially Z-shape shape;

FIG. 4 is a perspective view of the conduit illustrated in FIG. 1, after a bend of the conduit has been formed into a desired shape;

FIG. 5 is a perspective view of the conduit illustrated in FIG. 1, after a flange has been formed on a first end of the conduit and a desired diameter of a second end of the conduit has been formed; and

FIG. 6 is a perspective view of the conduit illustrated in FIG. 1, after a punch has been used to expand the second end of the conduit to a desired shape.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed and illustrated, the steps presented are exemplary in nature, and thus, the order of the steps is not necessary or critical.

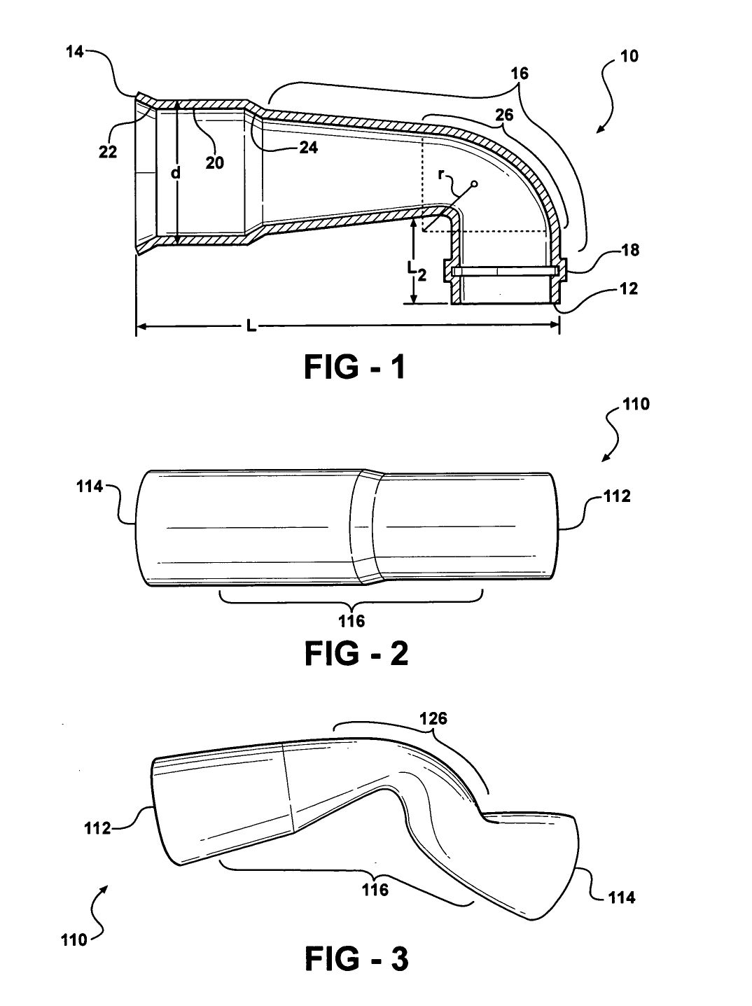

FIG. 1 shows a conduit 10 in accordance with an embodiment of the invention. In the embodiment shown, the conduit 10 is formed from aluminum. However, other materials can be used to form the conduit 10 as desired. The conduit 10 includes a diameter d, a length L, a first end 12, a spaced apart second end 14, and an intermediate portion 16. The intermediate portion 16 is disposed between the first end 12 and the second end 14. In the illustrated embodiment, the length L of the conduit 10 is less than three times (3×) the diameter d thereof. However, other configurations can be used as desired.

The first end 12 is substantially rectangular in cross section and is adapted to be connected to an inlet or outlet of a heat exchanger tank (not shown). It is understood that the first end 12 may have other cross sectional shapes and can be connected to other components as desired without departing from the scope and spirit of the invention. A flange 18 is formed on the conduit 10 adjacent the first end 12. The flange 18 is adapted to facilitate connection with the inlet or outlet of the heat exchanger tank.

The second end 14 is substantially circular in cross section and is adapted to be connected to an extension tube (not shown). It is understood that the second end 14 may have other cross sectional shapes and can be connected to other components as desired without departing from the scope and spirit of the invention. The second end 14 of the conduit 10 includes a flange 22 extending radially outwardly from the conduit 10 at an angle. An inner wall 20 of the conduit 10 adjacent to the second end 14 includes a sloped ridge 24. The sloped second ridge 24 is adapted to abut a distal end of the connector tube. Optionally, an O-ring (not shown) can be disposed between an outer wall of the extension tube and the inner wall 20 of the conduit 10 adjacent the flange 22.

The intermediate portion 16 includes a bend 26 formed therein. The bend 26 is approximately ninety degrees and includes a bend radius r. In the embodiment shown, the bend radius r is less than the diameter d of the conduit 10. A length L2 of a first leg of the conduit 10 adjacent the first end 12 thereof is also less than the diameter d of the conduit 10.

In use, the first end 12 of the conduit 10 is received by the inlet or outlet of the heat exchanger tank, so the inlet or outlet abuts the flange 18. The second end 14 of the conduit 10 receives the connector tube. When assembled, the sloped second ridge 24 of the conduit 10 abuts a distal end of the connector tube. The O-ring disposed between the outer wall of the connector tube and the inner wall 20 of the conduit 10 adjacent the flange 22 forms a substantially fluid tight seal therebetween. A fluid (not shown) is caused to flow through the connector tube into the conduit 10 and into the inlet of the heat exchanger tank. It is understood that the flow pattern is reversed if the conduit 10 is connected to an outlet of a heat exchanger tank.

Since the bend radius r of the conduit 10 is smaller than the diameter d of the conduit, the size of the package required to house the conduit 10 and the costs associated with the shipment thereof are minimized. Further, since the first end 12 of the conduit 10 has a rectangular cross section, the conduit 10 can be connected directly to the inlet or outlet of the heat exchanger tank, which are typically rectangular in cross section, without the use of additional tubes or conduits. Additionally, since the second end 14 of the conduit 10 has a circular cross section, the conduit 10 can be connected directly to the connector tube, which is typically circular in cross section, without the use of additional tubes or conduits. Accordingly, the cost required for producing the heater core and the time and effort required for the assembly thereof are minimized.

A method of forming the conduit 10 illustrated in FIG. 1 will now be described. A hollow conduit 110 is provided, as shown in FIG. 2. Preferably, the hollow conduit 110 is formed from aluminum or an aluminum alloy. However, other materials may be used to form the conduit 110 as desired. The conduit 110 is cut to produce a desired length L. The conduit 110 includes a first end 112, a spaced apart second end 114, and an intermediate portion 116 disposed between the first end 112 and the second end 114.

The conduit 110 is then placed in a die (not shown) and formed into a substantially Z-shape by crushing the conduit 110 where a bend 126 is to be formed, as shown in FIG. 3. The die is also used to form the first end 112 of the hollow conduit 110 into a substantially rectangular shape.

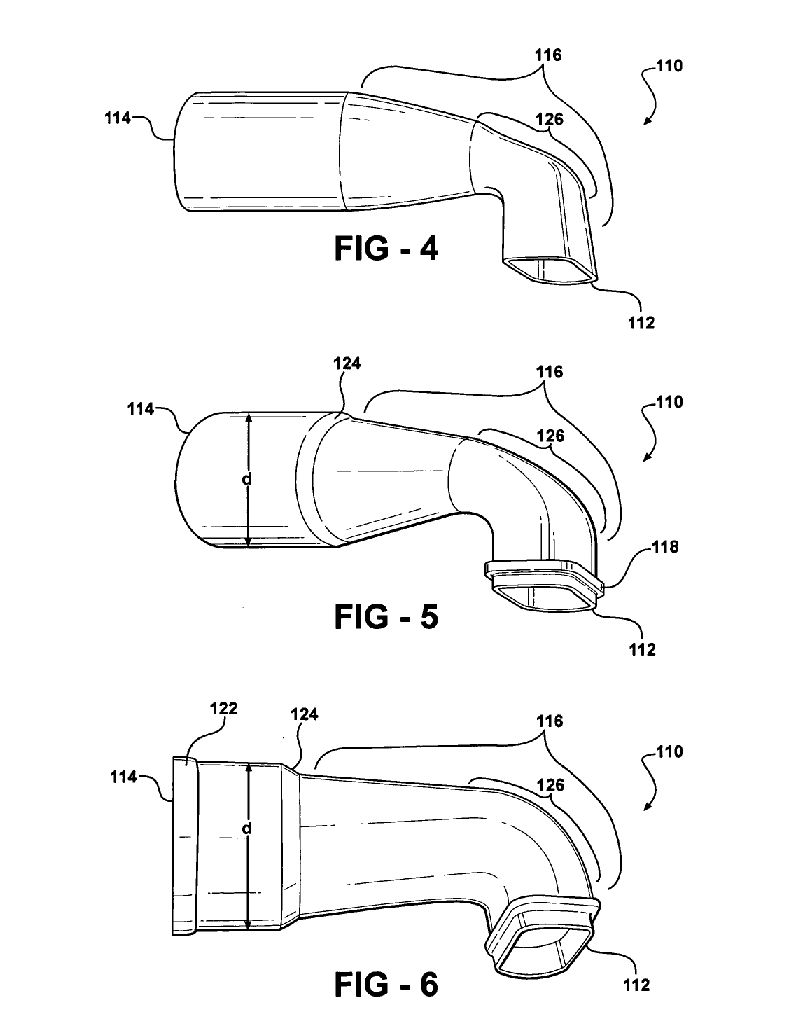

Thereafter, the conduit 110 is placed in a second die (not shown). The second die is used to complete the bend 126 in the conduit 110 and to shape the second end 114 of the conduit 110 in a process similar to hydroforming. The first end 112 of the conduit 110 is plugged to form a substantially fluid tight seal. A fluid (not shown) capable of transmitting hydraulic force, such as water, for example, is disposed in the conduit 110. A ram is introduced into the second end 114 of the conduit 110 to hydraulically expand the conduit 110 and form the bend 126 into the desired shape, as shown in FIG. 4. Thereafter, the second die is used to form a second ridge 124 on the conduit 110 and to form a desired diameter d of the conduit 110. A flange 118 is formed on the conduit 110 in the second die, as shown in FIG. 5.

Finally, a punch (not shown) is introduced into the second end 114 of the conduit 110. The punch is used to expand the conduit 110 at the second end 114 to form the flange 122 as shown in FIG. 6.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A tube comprising:
a hollow conduit having a first end, a spaced apart second end, and an intermediate portion, the intermediate portion having a bend formed therein, wherein a radius of the bend is less than a diameter of the conduit.

2. The tube according to claim 1, wherein the first end is adapted to connect to a heat exchanger tank.

3. The tube according to claim 2, wherein the first end of the conduit has a substantially rectangular cross section.

4. The tube according to claim 1, wherein the second end is adapted to connect to an extension tube.

5. The tube according to claim 4, wherein the second end of the conduit has a substantially circular cross section.

6. The tube according to claim 1, wherein the conduit is formed from aluminum.

7. The tube according to claim 1, wherein a length of the conduit is less than three times the diameter of the conduit.

8. The tube according to claim 1, wherein the bend formed in the conduit is approximately ninety degrees.

9. The tube according to claim 1, wherein a distance of a first leg of the tube to the second end of the tube is less than the diameter of conduit.

10. A tube comprising:
a hollow conduit having a first end, a spaced apart second end, and an intermediate portion, wherein the first end is adapted to be connected to a heat exchanger tank, the second end is adapted to be connected to a connector tube, and the intermediate portion includes a bend formed therein, wherein the bend has a radius that is less than a diameter of the hollow conduit and the conduit has a length that is less than three times the diameter thereof.

11. The tube according to claim 10, wherein the first end of the conduit has a substantially rectangular cross section.

12. The tube according to claim 10, wherein the second end of the conduit has a substantially circular cross section.

13. The tube according to claim 10, wherein conduit is formed from aluminum.

14. The tube according to claim 10, wherein a distance of a first leg of the tube to the second end of the tube is less than the diameter of conduit.

15. A method of forming a tube for a heat exchanger comprising the steps of:
providing a hollow conduit;
cutting the conduit to a desired length; and
forming a bend in the conduit, wherein the bend is approximately ninety degrees and has a bend radius that is less than the diameter of the tube.

16. The method according to claim 15, further comprising the step of forming a first end of the tube into one of a substantially rectangular cross section, a substantially oval cross section, and a substantially circular cross section.

17. The method according to claim 16, further comprising the step of forming a second end of the tube into one of a substantially rectangular cross section, a substantially oval cross section, and a substantially circular cross section.

18. The method according to claim 17, further comprising the step of expanding the first end of the tube to form a flange thereon.

19. The method according to claim 15, further comprising the steps of disposing the conduit into a first die and crushing the conduit into a substantially Z-shape.

20. The method according to claim 19, further comprising the steps of disposing the conduit into a second die, causing a fluid to be contained in the conduit, and compressing the fluid to cause the conduit to be expanded to a desired shape.
